(19) United States
(12) Patent Application Publication
(10) Pub. No.: US 2025/0305097 A1
(43) Pub. Date: Oct. 2, 2025

(54) MAGNETIC INDUCTOR ALLOYS

(71) Applicant: Xtalic Corporation, Marlborough, MA (US)

(72) Inventors: Evgeniya Freydina, Ashland, MA (US); Robert D. Hilty, Walpole, MA (US)

(73) Assignee: Xtalic Corporation, Marlborough, MA (US)

(21) Appl. No.: 19/009,842

(22) Filed: Jan. 3, 2025

Related U.S. Application Data
(60) Provisional application No. 63/617,879, filed on Jan. 5, 2024.

(51) Int. Cl. C22C 30/00

(52) U.S. Cl. CPC C22C 30/00; C22C 2200/04

(57) ABSTRACT

Alloys comprising a magnetic element, such as iron, nickel, and/or cobalt, and a resistance-enhancing material, and related compositions and methods, are generally described. In some embodiments, the alloy further comprises a grain size-reducing material. The resistance-enhancing material and/or the grain size-reducing material may increase the resistance (e.g., resistivity) of the alloy while still maintaining the magnetic properties of the alloy, which can improve the inductive properties of the alloy, or a composition comprising the alloy.

### RELATED APPLICATIONS

This application claims priority under 35 U.S.C. § 119 (e) to U.S. Provisional Patent Application No. 63/617,879, filed Jan. 5, 2024, and entitled “MAGNETIC INDUCTOR ALLOYS,” which is incorporated herein by reference in its entirety for all purposes.

### TECHNICAL FIELD

Alloys comprising a magnetic element, such as iron, nickel, and/or cobalt, and a resistance-enhancing material and/or grain size-reducing material are generally described.

### BACKGROUND

In the production and fabrication of an inductor component or device, there may be a benefit to using a material which is magnetic. Specifically, there can be advantages in terms of the electrical loss characteristics if the inductor includes a magnetic material. The state of the art describes several attempts. These include the use of magnetic composite materials which combine magnetic particles encapsulated into a polymeric encapsulant. This approach uses compacted particles, but the magnetic and conductive domains of these composites are contained within each particle, rather than form the entirety of the material. This leads to a larger inductor size due to various manufacturing constraints.

Other researchers have considered binary materials like Ni—Fe. These can be made in powder or electroplated forms and contribute to the inductance boost when plated over a conductor like copper. Still others have looked at higher order alloys, like Ni—Fe—Co, where the more complicated alloy leads to improvement in magnetic properties with a boost in inductance and sometimes a reduction in AC resistance. These alloys can often provide great benefit but for applications where the lowest electrical loss is desired, the magnetic material should be more electrically resistive than these alloys. A ternary alloy like Ni—Fe—Co is known to have a resistivity of around 50 μΩ·cm.

Accordingly improved alloy compositions with higher resistivities are desired.

### SUMMARY

Alloys comprising a magnetic element, such as iron, nickel, and/or cobalt, and a resistance-enhancing material, and related compositions and methods, are generally described. In some embodiments, the alloy further comprises a grain size-reducing material. The resistance-enhancing material and/or the grain size-reducing material may increase the resistance (e.g., resistivity) of the alloy while still maintaining the magnetic properties of the alloy, which can improve the inductive properties of the alloy, or a composition comprising the alloy. The subject matter of the present disclosure involves, in some cases, interrelated products, alternative solutions to a particular problem, and/or a plurality of different uses of one or more systems and/or articles.

In one aspect, a composition is described, the composition comprising an alloy comprising a magnetic material comprising iron, nickel, and/or cobalt, a resistance-enhancing material, and a grain size-reducing material, wherein the magnetic material is less than or equal to 95 wt % of the alloy, the resistance-enhancing material is less than or equal to 10 wt % of the alloy, and the grain size-reducing material is less than or equal to 25 wt % of the alloy. In some embodiments, a resistivity of the alloy is greater than or equal to 100 μΩ·cm.

In another aspect, a composition comprising an alloy, comprising nickel; cobalt; iron; oxygen; phosphorus; and tungsten, wherein a resistivity of the alloy is greater than or equal to 100 μΩ·cm is described.

In another aspect, a composition is described, the composition comprising an alloy comprising a magnetic material, the magnetic material comprising iron, nickel, and/or cobalt; and resistance-enhancing material comprising oxygen and/or phosphorus, wherein a resistivity of the alloy is greater than or equal to 100 μΩ·cm.

In yet another aspect, a composition is described, the composition comprising an alloy comprising a magnetic material, the magnetic material comprising iron, nickel, and/or cobalt; and a grain size-reducing material comprising tungsten, wherein a resistivity of the alloy is greater than or equal to 100 μΩ·cm.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### DETAILED DESCRIPTION

Described herein are compositions for various alloys in which the resistivity of the alloy is enhanced by the addition of certain elements. For example, the resistivity of an alloy may be increased by the addition of these certain elements, which can also improve the inductive properties of the alloy. The alloys include at least one magnetic element, such as iron (Fe), nickel (Ni), and/or cobalt (Co). The alloy compositions also include other elements, such as elements that increase the resistivity of the alloy, like oxygen (O) and/or phosphorus (P), and/or elements, such as tungsten (W), that improve the grain qualities of the alloy, for example, by reducing a grain size of the crystallites within the alloy. Accordingly, some of the alloys described herein are alloys with relatively small grain sizes, which may result in nanocrystalline alloys (i.e., alloys with an average grain size on the nanoscale).

The Inventors have recognized and appreciated that the inclusion of these elements in the alloy compositions described herein may maintain or improve the qualities of the alloy (e.g., a retention of the inductive properties of the alloy relative to the alloy without the inclusion of these elements), while increasing the beneficial qualities of the alloy, such as its electrical resistivity. By way of illustration (and not limitation), one element that the Inventors have recognized improves the resistivity of the resulting alloy is oxygen. However, with conventional alloys, oxygen is known to form surface oxides having a relatively low conductivity. These oxides may also negatively impact the qualities of the alloy, for example, by creating an alloy that is too brittle. Surprisingly, the inclusion of oxygen in the alloys described herein did not provide these negative qualities while increasing the resistivity of the alloy.

Typically, either a resistance-enhancing material or a grain size-reducing material is added to a magnetic material to increase resistivity of a resulting alloy composition. When adding either the resistance-enhancing material or the grain size-reducing material to the alloy composition to obtain a desirable resistivity, a corresponding amount of the magnetic material is displaced. Typically, to obtain a desirable resistivity, a large amount of magnetic material is displaced from the alloy by either the resistance-enhancing material or the grain size-reducing material, thereby resulting in an alloy composition with insufficient magnetic properties.

In view of the above, in accordance with some embodiments, the inventors have recognized the benefits of including both a resistance-enhancing material and a grain size-reducing material in the alloy compositions described herein. Without wishing to be bound by any particular theory, it is believed that the resistance-enhancing material and the grain size-reducing material increase the resistivity of alloys containing them via different mechanisms. Moreover, the inclusion of both materials unexpectedly and synergistically increases the resistivity of the resulting alloy composition, relative to an alloy composition including either the resistance-enhancing material or the grain size-reducing material in an equivalent total amount. Thus, compared to typical compositions, a small total amount of the resistance-enhancing material and the grain size-reducing material may be included in the alloy compositions to obtain an alloy composition having a desired resistivity, in some embodiments. Accordingly, in some cases, the amount of magnetic material within the alloy may be high because less of it is displaced by the resistance-enhancing material and/or the grain size-reducing material than in typical alloys. In this manner, in some embodiments, the alloy compositions described herein may retain the desirable magnetic properties of the magnetic material while also exhibiting a desired resistivity.

A variety of alloy compositions are described herein. For example, in some embodiments, the composition includes a magnetic material and a resistance-enhancing material. In some such embodiments, the magnetic material includes iron, nickel, and/or cobalt, and the resistance-enhancing material includes oxygen and/or phosphorus. In some embodiments, the composition includes an alloy comprising a magnetic material and a grain size-reducing material. In some such embodiments, the grain size-reducing material includes tungsten. In some embodiments, the composition comprises an alloy that includes nickel, cobalt, iron, oxygen, phosphorus, and tungsten. For each of these alloys, the inclusion of the resistance-enhancing material and/or the grain size-reducing material may increase the resistivity of the resulting alloy (e.g., to greater than or equal to 100 μΩ·cm) such that the magnetic properties of the alloy are maintained, but not so much that the alloy becomes semiconductive or completely resistive (e.g., having a resistivity of greater than 10,000 μΩ·cm). Said in another way, the inclusion of the resistance-enhancing material and/or the grain size-reducing material to the alloy increases the resistivity of the alloy without transforming the alloy into a semiconductor or a resistor.

As noted above, the compositions described herein include alloys that are primarily a mixture of metallic elements. For example, in some embodiments, the alloy comprises nickel, iron, and/or cobalt. However, other elements (either metallic or non-metallic) may be included. In some embodiments, for example, the alloy comprises oxygen and/or phosphorus. In some embodiments, the alloy comprises tungsten. Other elements are possible and, in some cases, are described in more detail elsewhere herein.

For many embodiments, the alloys are nanocrystalline alloys. That is to say, in some embodiments, the alloy is nanocrystalline where the average grain size is less than or equal to 100 nm. Advantageously, the inclusion of a grain size-reducing material, such as tungsten, may facilitate average grain sizes in the nanometer range. In some embodiments, an average grain size of the alloy is less than or equal to 100 nm, less than or equal to 50 nm, less than or equal to 25 nm, less than or equal to 20 nm, less than or equal to 15 nm, or less than or equal to 10 nm. In some embodiments, an average grain size of the alloy is greater than or equal to 5 nm, greater than or equal to 10 nm, greater than or equal to 15 nm, greater than or equal to 20 nm, greater than or equal to 25 nm, or greater than or equal to 50 nm. Combinations of the foregoing range are also possible (e.g., less than or equal to 100 nm and greater than or equal to 10 nm). Of course, other ranges are possible as this disclosure is not so limiting.

In some embodiments, an alloy composition comprises an alloy with two or more metals. In some embodiments, the alloy composition comprises greater than or equal to 2 metals, greater than or equal to 3 metals, greater than or equal to 4 metals, greater than or equal to 5 metals, greater than or equal to 6 metals, greater than or equal to 7 metals, or greater than or equal to 8 metals. In some embodiments, the alloy composition comprises less than or equal to 9 metals, less than or equal to 8 metals, less than or equal to 7 metals, less than or equal to 6 metals, less than or equal to 5 metals, less than or equal to 4 metals, or less than or equal to 3 metals. Combinations of the foregoing ranges are possible (e.g., greater than or equal to 2 metals and less than or equal to 9 metals). Other ranges are also possible.

In some embodiments, an alloy composition includes a grain size-reducing material. In some embodiments, an alloy composition including of a grain size-reducing material, such as tungsten, may have advantages relative to alloys absent the grain size-reducing material, all other factors being equal. For example, the inventors have recognized the benefits of including tungsten in alloys (e.g., nickel-cobalt alloys, nickel-iron alloys, and/or nickel-iron-cobalt alloy). For example, tungsten may reduce the grain size of certain alloys, relative to alloys absent the grain size-reducing material, all other factors being equal. A decreased grain size, in some embodiments, may increase the resistivity of the alloy. It should be appreciated that grain size-reducing materials other than tungsten may also provide these benefits to binary and/or ternary alloys, as described elsewhere herein. It should further be understood that an alloy composition comprising the grain size-reducing material, in some embodiments, may have a decreased grain size as compared to an alloy composition absent the grain size-reducing material, all other factors being equal.

In some embodiments, an alloy composition comprises three or more elements. In some embodiments, the elements contained in the alloy composition may each independently be a metal, a metalloid, and/or a non-metal. For instance, as a non-limiting example, an alloy composition may include at least three elements such as the metals iron and tungsten and the non-metal oxygen. In some embodiments, the alloy composition comprises greater than or equal to 3 elements, greater than or equal to 4 elements, greater than or equal to 5 elements, greater than or equal to 6 elements, greater than or equal to 7 elements, or greater than or equal to 8 elements. In some embodiments, the alloy composition comprises less than or equal to 9 elements, less than or equal to 8 elements, less than or equal to 7 elements, less than or equal to 6 elements, less than or equal to 5 elements, less than or equal to 4 elements, or less than or equal to 3 elements. Combinations of the foregoing ranges are possible (e.g., greater than or equal to 3 elements and less than or equal to 9 elements). Other ranges are also possible.

Various of the alloys described herein are magnetic alloys and may include an element or a material that possesses magnetic properties. For example, in some embodiments, the magnetic material of the alloy comprises iron, nickel, and/or cobalt. In some embodiments, the magnetic material is greater than or equal to 50 wt %, greater than or equal to 75 wt %, greater than or equal to 90 wt %, or greater than or equal to 95 wt % of the alloy, or a composition comprising the alloy. In some embodiments, the magnetic material is less than or equal to 95 wt %, less than or equal to 90 wt %, less than or equal to 75 wt %, or less than or equal to 50 wt % of the alloy, or a composition comprising the alloy. Combinations of the above-referenced ranges are also possible (e.g., greater than or equal to 5 wt % and less than or equal to 95 wt % of the alloy is the magnetic material). Other ranges are possible.

In some embodiments, the alloy comprises nickel. In some embodiments, an amount of nickel in the alloy is greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 55 wt %. In some embodiments, an amount of nickel in the alloy is less than or equal to 60 wt %, less than or equal to 55 wt %, less than or equal to 50 wt %, less than or equal to 40 wt %, less than or equal to 35 wt %, less than or equal to 30 wt %, less than or equal to 25 wt %, less than or equal to 20 wt %, or less than or equal to 15 wt %. Combinations of the above-referenced ranges are also possible (e.g., greater than or equal to 15 wt % and less than or equal to 60 wt % or greater than or equal to 20 wt % and less than or equal to 50 wt %). Other ranges are possible.

In some embodiments, the alloy comprises cobalt. In some embodiments, an amount of cobalt in the alloy is greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 50 wt %. In some embodiments, an amount of cobalt in the alloy is less than or equal to 50 wt %, less than or equal to 40 wt %, less than or equal to 35 wt %, less than or equal to 30 wt %, less than or equal to 25 wt %, less than or equal to 20 wt %, or less than or equal to 15 wt %. Combinations of the above-referenced ranges are also possible (e.g., greater than or equal to 15 wt % and less than or equal to 50 wt %). Other ranges are possible.

In some embodiments, the alloy comprises iron. In some embodiments, an amount of iron in the alloy is greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 50 wt %. In some embodiments, an amount of iron in the alloy is less than or equal to 50 wt %, less than or equal to 40 wt %, less than or equal to 35 wt %, less than or equal to 30 wt %, less than or equal to 25 wt %, less than or equal to 20 wt %, or less than or equal to 15 wt %. Combinations of the foregoing ranges are also possible (e.g., greater than or equal to 40 wt % and less than or equal to 50 wt %). Other ranges are possible.

As was noted above and elsewhere herein, the alloy compositions described herein may also include a resistance-enhancing material. The resistance-enhancing material may alter the resistivity of the alloy, for example, by increasing a resistivity of the alloy, relative to an alloy of the same composition, except for the inclusion of the resistance-enhancing material. Without wishing to be bound by any particular theory, it is believed that the inclusion of the resistance-enhancing material in the alloy reduces the mean free path of electrons traveling within the alloy, which increases the resistivity of the resulting alloy. Advantageously, the resistance-enhancing material may be located throughout the bulk of the alloy, rather than just on the surface of the alloy. As a non-limiting example, in some embodiments where the resistance-enhancing material comprises oxygen, the oxygen may be distributed throughout the bulk of the alloy rather than only present on the surface of the alloy.

For some embodiments, the resistance-enhancing material comprises oxygen and/or phosphorus. However, other materials are possible. In some embodiments, for example, the resistance-enhancing material is selected from the elements O, P, S, C, N, Sb, and Bi.

In some embodiments, the resistance-enhancing material advantageously increases the resistivity of the of the alloy, but not so much that the alloy becomes semiconducting or non-conducting (i.e., an insulator). In some embodiments, a resistivity of the alloy is greater than or equal to 100 μΩ·cm, greater than or equal to 200 μΩ·cm, greater than or equal to 300 μΩ·cm, greater than or equal to 350 μΩ·cm, greater than or equal to 400 μΩ·cm, greater than or equal to 500 μΩ·cm, greater than or equal to 750 μΩ·cm, or greater than or equal to 1,000 μΩ·cm. In some embodiments, a resistivity of the alloy is less than or equal to 1,000 μΩ·cm, less than or equal to 750 μΩ·cm, less than or equal to 500 μΩ·cm, less than or equal to 400 μΩ·cm, less than or equal to 350μΩ·cm, less than or equal to 300μΩ·cm, less than or equal to 200μΩ·cm, or less than or equal to 100 μΩ·cm. Combinations of the above-referenced ranges are also possible (e.g., greater than or equal to 100 μΩ·cm and less than or equal to 1,000 μΩ·cm). Other ranges are possible as this disclosure is not so limiting. It should be understood that an alloy composition comprising the resistance-enhancing material, in some embodiments, may have an increased resistivity compared to an alloy composition absent the resistance-enhancing material, all other factors being equal.

The resistance-enhancing material (e.g., oxygen and/or phosphorus) is present within the alloy at a particular amount. In some embodiments, the resistance-enhancing material is less than or equal to 10 wt %, less than or equal to 7 wt %, less than or equal to 5 wt %, less than or equal to 3 wt %, less than or equal to 1 wt %, less than or equal to 0.5 wt %, or less than or equal to 0.1 wt % of the alloy, or a composition comprising the alloy. In some embodiments, the resistance-enhancing material is greater than or equal to 0.1 wt %, greater than or equal to 0.5 wt %, greater than or equal to 1 wt %, greater than or equal to 3 wt %, greater than or equal to 5 wt %, greater than or equal to 7 wt %, or greater than or equal to 10 wt % of the alloy, or a composition comprising the alloy. Combinations of the above-referenced ranges are also possible (e.g., greater than or equal to 0.1 wt % and less than or equal to 10 wt %). Other ranges are possible. In some embodiments, when multiple resistance-enhancing materials are present, the total amount of the multiple resistance-enhancing materials may correspond to any of the foregoing ranges. In some embodiments, when multiple resistance-enhancing materials are present, the amount of each of the multiple resistance-enhancing materials may independently correspond to any of the foregoing ranges.

In some embodiments, the alloy comprises oxygen. In some embodiments, an amount of oxygen in the alloy is less than or equal to 10 wt %, less than or equal to 7 wt %, less than or equal to 5 wt %, less than or equal to 3 wt %, less than or equal to 1 wt %, less than or equal to 0.5 wt %, or less than or equal to 0.1 wt %. In some embodiments, an amount of oxygen in the alloy is greater than or equal to 0.1 wt %, greater than or equal to 0.5 wt %, greater than or equal to 1 wt %, greater than or equal to 3 wt %, greater than or equal to 5 wt %, greater than or equal to 7 wt %, or greater than or equal to 10 wt %. Combinations of the above-referenced ranges are also possible (e.g., greater than or equal to 0.1 wt % and less than or equal to 10 wt %). Other ranges are possible.

In some embodiments, the alloy comprises phosphorus. In some embodiments, an amount of phosphorus in the alloy is less than or equal to 10 wt %, less than or equal to 7 wt %, less than or equal to 5 wt %, less than or equal to 3 wt %, less than or equal to 1 wt %, less than or equal to 0.5 wt %, or less than or equal to 0.1 wt %. In some embodiments, an amount of phosphorus in the alloy is greater than or equal to 0.1 wt %, greater than or equal to 0.5 wt %, greater than or equal to 1 wt %, greater than or equal to 3 wt %, greater than or equal to 5 wt %, greater than or equal to 7 wt %, or greater than or equal to 10 wt %. Combinations of the above-referenced ranges are also possible (e.g., greater than or equal to 0.1 wt % and less than or equal to 10 wt %). Other ranges are possible as this disclosure is not so limiting.

As mentioned elsewhere herein, the alloy compositions may also include a material that reduces the (average) grain size of the alloy, i.e., a grain-size reducing material. In some embodiments, the grain size-reducing material comprises tungsten. However, other grain size-reducing materials are possible. In some embodiments, the grain size-reducing material comprises molybdenum (Mo), lead (Pb), and/or tungsten. In some embodiments, the grain size-reducing material is selected from the elements Ag, Al, Au, Cr, Cu, Mg, Mo, Pb, Pd, Pt, Ta, Ti, W, and Zr.

The grain size-reducing material may be present within the alloy, or a composition comprising the alloy, at a particular amount. In some embodiments, the grain size-reducing material is greater than or equal to 0.1 wt %, greater than or equal to 1 wt %, greater than or equal to 3 wt %, greater than or equal to 5 wt %, greater than or equal to 10 wt %, greater than or equal to 12 wt %, greater than or equal to 15 wt %, greater than or equal to 20 wt %, or greater than or equal to 25 wt % of the alloy, or a composition comprising the alloy. In some embodiments, the grain size-reducing material is less than or equal to 25 wt %, less than or equal to 20 wt %, less than or equal to 15 wt %, less than or equal to 12 wt %, less than or equal to 10 wt %, less than or equal to 5 wt %, less than or equal to 3 wt %, less than or equal to 1 wt %, or less than or equal to 0.1 wt % of the alloy, or a composition comprising the alloy. Combinations of the foregoing ranges are also possible (e.g., greater than or equal to 0.1 wt % and less than or equal to 25 wt %). Other ranges are possible. In some embodiments, when multiple grain size-reducing materials are present, the total amount of the multiple grain size-reducing materials may correspond to any of the foregoing ranges. In some embodiments, when multiple grain size-reducing materials are present, the amount of each of the multiple grain size-reducing materials may independently correspond to any of the foregoing ranges.

In some embodiments, the alloy comprises tungsten. In some embodiments, an amount of tungsten in the alloy is greater than or equal to 0.1 wt %, greater than or equal to 1 wt %, greater than or equal to 3 wt %, greater than or equal to 5 wt %, greater than or equal to 10 wt %, greater than or equal to 12 wt %, greater than or equal to 15 wt %, greater than or equal to 20 wt %, or greater than or equal to 25 wt %. In some embodiments, an amount of tungsten in the alloy is less than or equal to 25 wt %, less than or equal to 20 wt %, less than or equal to 15 wt %, less than or equal to 12 wt %, less than or equal to 10 wt %, less than or equal to 5 wt %, less than or equal to 3 wt %, less than or equal to 1 wt %, or less than or equal to 0.1 wt %. Combinations of the foregoing ranges are also possible (e.g., greater than or equal to 0.1 wt % and less than or equal to 25 wt %). Other ranges are possible.

As noted elsewhere herein, in some embodiments, the alloy compositions described herein include both a resistance-enhancing material and a grain size-reducing material. In some such embodiments, a desirable resistivity of the alloy composition is obtained, while retaining desirable magnetic properties from the magnetic material. For instance, in some embodiments, the alloy compositions described herein maintain at least 60%, at least 70%, at least 80%, at least 90%, or at least 95% of the magnetic properties of an otherwise identical alloy absent the resistance-enhancing material and the grain size-reducing material.

The alloy compositions described here may have a mixture of the various above-described components (e.g., a magnetic material and a resistance-enhancing material; a magnetic material and a grain size-reducing material; a magnetic material, a resistance-enhancing material, and a grain size-reducing material; nickel, cobalt, iron, oxygen, phosphorus, and tungsten). In one embodiment, the alloy comprises nickel (e.g., greater than or equal to 15 wt % of the alloy, greater than or equal to 25 wt % of the alloy, less than or equal to 60 wt % of the alloy, less than or equal to 50 wt % of the alloy, and/or less than or equal to 30 wt % of the alloy), cobalt (e.g., greater than or equal to 40 wt % of the alloy, greater than or equal to 45 wt % of the alloy, less than or equal to 50 wt % of the alloy, and/or less than or equal to 30 wt % of the alloy), iron (e.g., greater than or equal to 20 wt % of the alloy, greater than or equal to 25 wt % of the alloy, and/or less than or equal to 50 wt % of the alloy), oxygen (e.g., greater than or equal to 1 wt % of the alloy, greater than or equal to 3 wt % of the alloy, less than or equal to 5 wt % of the alloy, and/or less than or equal to 3 wt % of the alloy), phosphorus (e.g., greater than or equal to 0.1 wt % of the alloy, greater than or equal to 0.5 wt % of the alloy, less than or equal to 5 wt % of the alloy, and/or less than or equal to 3 wt % of the alloy), and tungsten (e.g., greater than or equal to 5 wt % of the alloy, greater than or equal to 7 wt % of the alloy, less than or equal to 25 wt % of the alloy, and/or less than or equal to 10 wt % of the alloy). In another embodiment, the alloy comprises nickel, iron, and/or cobalt; oxygen and/or phosphorus; and tungsten. In some embodiments, the alloy comprises a magnetic material, such as iron, nickel and/or cobalt, a resistance-enhancing material, such as phosphorus and/or oxygen, and a grain size-reducing material, such as tungsten. Of course, other mixtures of the various components described herein are possible, and those skilled in the art, in view of this disclosure, will be capable of selecting mixtures of the various components that provide the alloy (or a composition including the alloy) with the desired alloy properties described elsewhere herein.

The alloy compositions described herein comprise a mixture of elements and/or materials. For example, in some embodiments, the alloy composition comprises a magnetic material, a resistance-enhancing material, and a grain size-reducing material. In some embodiments, the alloy composition consists essentially of a magnetic material, a resistance-enhancing material, and a grain size-reducing material. In some embodiments, a total amount of the magnetic material, the resistance-enhancing material, and the grain size-reducing material is greater than or equal to 95%, greater than or equal to 99 wt %, greater than or equal to 99.9 wt %, or more of the alloy composition. In some embodiments, a total amount of the magnetic material, the resistance-enhancing material, and/or the grain size-reducing material is 100 wt % of the alloy or the composition. In some embodiments, a total amount of nickel, cobalt, iron, oxygen, phosphorus, and/or tungsten is greater than or equal to 95%, greater than or equal to 99 wt %, greater than or equal to 99.9 wt %, or more of the alloy composition. For example, in some embodiments, a total amount of nickel, cobalt, iron, oxygen, phosphorus, and/or tungsten is 100 wt % of the alloy or composition.

The alloy compositions described herein can be formed into a variety of articles. For example, in some embodiments, the alloy composition is a layer on a substrate (e.g., as a trace on a printed circuit board). In some embodiments, the composition is deposited as a coating on a wire (e.g., the alloy is applied on the surface of a copper wire). Of course, other articles are possible, some of which are described in more detail elsewhere herein.

The alloy compositions can be provided by a variety of methods known in the art. For example, in some embodiments, electrodeposition can be used to form the alloy compositions described herein. Electrodeposition generally involves the deposition of a material on a substrate by contacting the substrate with an electrodeposition bath and flowing electrical current between two electrodes through the electrodeposition bath, i.e., due to a difference in electrical potential between the two electrodes. For example, methods described herein may involve providing an anode, a cathode, an electrodeposition bath associated with (e.g., in contact with) the anode and cathode, and a power supply connected to the anode and cathode.

A variety of electrochemical baths may be used for electrodeposition process. In some embodiments, an electrodeposition bath comprises iron, cobalt, and/or nickel ionic species. In general, metal salts of Fe, Co, or Ni may be used as the sources of the metallic species. For example, these salts may comprise metal chlorides (e.g., FeCl₃), metal bromides, metal sulfates, metal nitrates, metal phosphates. Other metal salts or molecular species may be suitable as the disclosure is not so limited. Those of ordinary skill in the art, in view of the present disclosure, will be able to determine other appropriate salt for electrodeposition.

The electrodeposition process or processes may be modulated by varying the potential that is applied between the electrodes (e.g., potential control or voltage control), or by varying the current or current density that is allowed to flow (e.g., current or current density control). In some embodiments, the alloy(s) may be formed (e.g., electrodeposited) using direct current (DC) plating, pulsed current plating, reverse pulse current plating, or combinations thereof. In some embodiments, reverse pulse plating may be preferred. Pulses, oscillations, and/or other variations in voltage, potential, current, and/or current density, may also be incorporated during the electrodeposition process. For example, pulses of controlled voltage may be alternated with pulses of controlled current or current density. In general, during an electrodeposition process an electrical potential may exist on the substrate (e.g., base material) on which the alloy is formed, and changes in applied voltage, current, or current density may result in changes to the electrical potential on the substrate. In some cases, the electrodeposition process may include the use waveforms comprising one or more segments, wherein each segment involves a particular set of electrodeposition conditions (e.g., current density, current duration, electrodeposition bath temperature, etc.).

The alloy compositions described herein are suitable for a variety of purposes. For example, the inclusion of a resistance-enhancing (e.g., a resistance increasing, a resistivity increasing) material can improve or maintain the magnetic properties of the resulting composition, which may improve the inductive properties of the composition. Additionally, or alternatively, the grain size-reducing material may improve the overall crystallinity of the alloy, resulting in better properties (e.g., improved resistivity, improved grain size control, and/or improved hardness) in the alloy. In some embodiments, the inclusion of a resistance-enhancing material and/or a grain size-reducing material in an alloy or composition (e.g., throughout the bulk of the alloy or composition) may advantageously result in a nanocrystalline alloy and/or a composition having a resistivity desirable for induction applications, e.g., without resulting in a semiconducting or insulating alloy or composition. Accordingly, the compositions described herein may find uses in wireless charging (e.g., recharging) applications, which use inductive coils (and/or other geometries) to provide wireless recharging capabilities to certain electronic devices (e.g., smartphones, laptops, computers, etc., and corresponding charging devices). In some embodiments, the composition is applied on the surface of a PCB, a semiconductor chip, or a plated through hole of a circuit board. Of course, other applications are possible, and those skilled in the art, in view of this disclosure, will be capable of recognizing other applications in which inductive properties of magnetic alloys are of interest for a particular application.

The following examples are intended to illustrate certain embodiments of the present invention, but do not exemplify the full scope of the invention.

### Example 1

The following example describes a nickel-cobalt-iron alloy that also includes amounts of phosphorus and oxygen to boost the resistivity of the alloy and tungsten, for its grain size-reducing properties. The resulting alloy had a resistivity of greater than or equal to 100 μΩ·cm.

The alloy was created by electrodeposition with an unexpected boost in resistivity and a composition in weight % of: Ni: 18.3 wt %; Co: 45.3 wt %; Fe: 25.0 wt %; W: 7.0 wt %; P: 0.9 wt %; and O: 3.5 wt %. The resistivity of the alloy was 383 μΩ·cm.

### Example 2

The following example describes a nickel-cobalt-iron alloy that also includes amounts of phosphorus and oxygen to boost the resistivity of the alloy and tungsten, for its grain size-reducing properties. The resulting alloy had a resistivity of greater than or equal to 100 μΩ·cm.

The alloy was created by electrodeposition with an unexpected boost in resistivity and a composition in weight % of: Ni: 25.4 wt %; Co: 40.3 wt %; Fe: 21.5 wt %; W: 9.6 wt %; P: 0.5 wt %; and O: 2.7 wt %. The resistivity of the alloy was 419 μΩ·cm.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition, comprising:
an alloy comprising a magnetic material comprising iron, nickel, and/or cobalt, a resistance-enhancing material, and a grain size-reducing material,
wherein:
the magnetic material is less than or equal to 95 wt % of the alloy,
the resistance-enhancing material is less than or equal to 10 wt % of the alloy, and
the grain size-reducing material is less than or equal to 25 wt % of the alloy.

2. The composition of claim 1, wherein a resistivity of the alloy is greater than or equal to 100 μΩ·cm.

3. A composition, comprising:
an alloy, comprising:
nickel;
cobalt;
iron;
oxygen;
phosphorus; and
tungsten,
wherein a resistivity of the alloy is greater than or equal to 100 μΩ·cm.

4. A composition, comprising:
an alloy comprising a magnetic material, the magnetic material comprising iron, nickel, and/or cobalt; and
a grain size-reducing material comprising tungsten,
wherein a resistivity of the alloy is greater than or equal to 100 μΩ·cm.

5. The composition of claim 1, wherein the alloy is a nanocrystalline alloy.

6. The composition of claim 1, wherein the alloy comprises an average grain size of less than or equal to 100 nm.

7. The composition of claim 1, wherein a resistivity of the alloy is greater than or equal to 100μΩ·cm and less than or equal to 1,000μΩ·cm.

8. The composition of claim 1, wherein the resistance-enhancing material comprises oxygen and/or phosphorus.

9. (canceled)

10. The composition of claim 1, wherein the resistance-enhancing material is incorporated within the bulk of the alloy.

11. The composition of claim 1, wherein the resistance-enhancing material is greater than or equal to 0.1 wt % and less than or equal to 10 wt % of the alloy or the composition.

12. The composition of claim 1, wherein the grain size-reducing material comprises tungsten.

13. The composition of claim 1, wherein the grain size-reducing material is selected from the elements Ag, Al, Au, Cr, Cu, Mg, Mo, Pb, Pd, Pt, Ta, Ti, W, and Zr.

14. The composition of claim 1, wherein the grain size-reducing material is greater than or equal to 0.1 wt % and less than or equal to 25 wt % of the alloy or the composition.

15. The composition of claim 1, wherein an amount of nickel in the alloy is greater than or equal to 0.1 wt % and less than or equal to 60 wt %.

16. (canceled)

17. The composition of claim 1, wherein an amount of cobalt in the alloy is greater than or equal to 0.1 wt % and less than or equal to 50 wt %.

18. The composition of claim 1, wherein an amount of iron in the alloy is greater than or equal 0.1 wt % and less than or equal to 50 wt %.

19. The composition of claim 1, wherein an amount of oxygen in the alloy is greater than or equal to 0.1 wt % and less than or equal to 10 wt %.

20. The composition of claim 1, wherein an amount of phosphorus in the alloy is greater than or equal to 0.1 wt % and less than or equal to 10 wt %.

21. The composition of claim 1, wherein an amount of tungsten in the alloy is greater than or equal to 0.1 wt % and less than or equal to 25 wt %.

22-23. (canceled)

24. The composition of claim 1, wherein a resistivity of the alloy is greater than or equal to 200μΩ·cm.

25. (canceled)
